(19) United States
(12) Patent Application Publication
(10) Pub. No.: US 2010/0163000 A1
(43) Pub. Date: Jul. 1, 2010

(54) APPARATUS AND METHOD FOR CONTROLLING A FUEL INJECTOR UNDER ABNORMAL CONDITIONS

(76) Inventors: Yoshinori Futonagane, Shizuoka-ken (JP); Fumihiro Okumura, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/664,067

(22) PCT Filed: Jun. 13, 2008
(86) PCT No.: PCT/IB08/01520

§ 371 Date: Dec. 11, 2009

(30) Foreign Application Priority Data
Jun. 15, 2007 (JP) 2007-158439

(51) Int. Cl. F02M 51/00

(52) U.S. Cl. 123/478

(57) ABSTRACT

A control device (5) for an internal combustion engine including a fuel injection device (3) is provided. The fuel injection device (3) includes an injection hole (31b, 31c), and is configured to inject fuel from the injection hole (31b, 31c) into a combustion chamber (21). The control device (5) includes an actual injection amount output section (53), an injection amount deviation output section (51a), and an abnormality treatment direction section (51a). The injection amount deviation output section (51a) outputs a signal that indicates the deviation between an actual injection amount and a command fuel injection amount. The abnormality treatment direction section (51a) outputs a signal to enable treatment if the deviation exceeds a predetermined value.

### BACKGROUND OF THE INVENTION

1. Field of the Invention

The present invention relates to a control device for an internal combustion engine (which may hereinafter be referred to simply as “control device”) that includes a fuel injection device for injecting fuel from an injection hole into a combustion chamber, and to a method of controlling the internal combustion engine.

In particular, the present invention relates to a control device in which the fuel injection device has a first injection hole and a second injection hole and that switchably performs a first fuel injection mode and second fuel injection more.

The term “first fuel injection” as used herein refers to the injection of fuel from only the first injection hole into the combustion chamber. Whereas, the term “second fuel injection” as used herein refers to the injection of fuel from the first injection hole and the second injection hole into the combustion chamber.

2. Description of the Related Art

Devices of this type are described in Japanese Patent Application Publication No. 2002-310042 (JP-A-2002-310042) and Japanese Patent Application Publication No. 2005-201113 (JP-A-2005-201113), for example.

In the devices of this type, deposits are occasionally generated around and/or inside the outlet of the injection hole. The term “ deposits” as used herein refers to deposits of carbide, oxide, etc. The deposits are generated as unburned fuel is carbonized, for example, along with generation of a flame and/or high heat as a result of fuel combustion in the combustion chamber.

The injection hole becomes clogged by the deposits, which interferes with the fuel injection amount control. Therefore, if such clogging occurs, some treatment (for example, compulsory fuel injection to blow off the deposits) is required.

For example, the device described in JP-A-2002-310042 includes a first injection hole and a second injection hole. In this device, deposits may form at the second injection hole when fuel has not been injected from the second injection hole for an extended period of time (the first fuel injection has continued). Thus, in this device, a counter counts the number of times that the first fuel injection is performed, and fuel is compulsorily injected from the second injection hole when the counter has reached a predetermined value.

That is, in the device described in JP-A-2002-310042, clogging of the second injection hole is estimated using a counter which keeps incrementing while the first fuel injection is being performed, and the fuel is compulsorily injected from the second injection hole based on the results from the counter.

On the other hand, the device described in JP-A-2005-201113 performs a treatment to burn off deposits that have formed at the injection hole when the deposit has caused a decrease in the fuel injection amount.

Specifically, in this device, the formation of deposits at the injection hole cause the actual fuel injection amount (actual injection amount) to deviate from the target fuel injection amount and. In this event, air-fuel ratio feedback control is performed using an air-fuel ratio sensor to adjust the intake air amount. When the intake air amount is decreased by at least a predetermined amount, the amount of EGR gas in exhaust gas recirculation (EGR) is reduced to raise the combustion temperature. This burns off the deposit.

Thus, it is desirable for such devices to more accurately acquire or estimate the extent to which deposits have formed in order to more appropriately control the operation of the internal combustion engine.

### SUMMARY OF THE INVENTION

The present invention provides a control device more appropriately controls the operation of an internal combustion engine by more accurately acquiring or estimating the extent to which deposits have formed at an injection hole.

A first aspect of the present invention is directed to a control device for an internal combustion engine that includes a fuel injection device. The fuel injection device includes an injection hole, and it injects fuel from the injection hole into a combustion chamber.

Specifically, the fuel injection device may be disposed such that the injection hole is exposed into the combustion chamber. That is, the fuel injection device may be configured and disposed such that fuel is directly injected into the combustion chamber from the injection hole.

In addition, the fuel injection device may include a first injection hole and a second injection hole as the injection hole. In this case, the control-device and the fuel injection device switches between a first fuel injection mode, in which fuel is injected from only the first injection hole into the combustion chamber, and second fuel injection mode, in which fuel is injected from the first injection hole and the second injection hole into the combustion chamber.

In the first aspect of the present invention, the control device includes an actual injection amount output section (actual injection amount output means), an injection amount deviation output section (injection amount deviation output means), and an abnormality treatment direction section (abnormality treatment command means).

Here, the actual injection amount output section outputs a signal that indicates an actual injection amount in the second fuel injection mode, for example. The actual injection amount represents the amount of fuel that is actually injected from the fuel injection device.

In addition, the injection amount deviation output section outputs a signal that indicates the deviation between the actual injection amount and a command fuel injection amount. The command fuel injection amount represents a fuel injection amount (or a corresponding signal) that is input to the fuel injection device to cause the fuel injection device to inject a predetermined target fuel injection amount of fuel. The target fuel injection amount can be set according to the operating conditions. The command fuel injection amount may be the same as the target fuel injection amount. Alternatively, the command fuel injection amount may be generated by making a predetermined correction to the target fuel injection amount.

Further, the abnormality treatment direction section outputs an abnormality treatment signal based on the output of the injection amount deviation output section when the deviation is more than a predetermined value. The abnormality treatment signal enables abnormality treatment different from normality treatment. An appropriate abnormality treatment may include, for example, a compulsory injection of fuel from the (second) injection hole, or determining that the fuel injection device has malfunctioned. The abnormality treatment direction section may be configured to output an abnormality treatment signal based on the output of the injection amount deviation output section if the target fuel injection amount or the command fuel injection amount exceeds a predetermined amount.

In such a configuration, the actual injection amount output section outputs a signal that indicates the actual injection amount. Based on this output and the command fuel injection amount, the injection amount deviation output section outputs a signal that indicates the deviation. Then, the abnormality treatment direction section outputs an abnormality treatment signal when the deviation exceeds a predetermined value. A predetermined abnormality treatment is performed based on the abnormality treatment signal.

According to the first aspect of the invention, the extent to which deposits have formed may be more accurately determined based on the deviation. This allows to more appropriately perform abnormality treatment, such as compulsorily injecting fuel from the (second) injection hole, or in determining that the fuel injection device has malfunctioned. Thus; according to the first aspect of the invention, the operation of the internal combustion engine is more appropriately controlled.

A second aspect of the invention is drawn to a control method for an internal combustion engine that includes a fuel injection device that switches between performing a first fuel injection, in which fuel is injected into a combustion chamber from only a first injection hole, and a second fuel injection, in which fuel is injected into the combustion chamber from both the first injection hole and a second injection hole. The control method includes: producing an output corresponding to an actual injection amount, which represents an amount of fuel actually injected from, the fuel injection device during the second fuel injection; producing an output corresponding to a deviation between the actual injection amount and a command fuel injection amount which is input to the fuel injection device to cause the fuel injection device to inject a predetermined target fuel injection amount of fuel; and outputting an abnormality treatment signal which enables abnormality treatment different from normality treatment based on the output corresponding to the deviation when the deviation exceeds a predetermined value.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a schematic diagram showing the overall configuration of an engine control system to which an embodiment of the present invention is applied;

FIG. 2A, FIG. 2B, and FIG. 2C are each a side cross sectional view showing as enlarged the tip of the nozzle shown in FIG. 1;

FIG. 3 is a conceptual diagram showing the outline of how the engine control device of the embodiment shown in FIG. 1 detects the extent to which deposits have formed;

FIG. 4 is a flowchart showing an example of the deposit abnormality determination routine that is executed by the engine control device shown in FIG. 1;

FIG. 5 is a conceptual diagram showing a specific example of how the engine control device of the embodiment shown in FIG. 1 detects the extent to which deposits have formed;

FIG. 6A and FIG. 6B are flowcharts showing an example of the deposit amount estimation routine that is executed by the engine control device shown in FIG. 1; and

FIG. 7A and FIG. 7B are flowcharts showing an example of the deposit abnormality treatment routine that is executed by the engine control device shown in FIG. 1.

### DETAILED DESCRIPTION OF EMBODIMENTS

A description will hereinafter be made of an embodiment of the present invention with reference to the drawings.

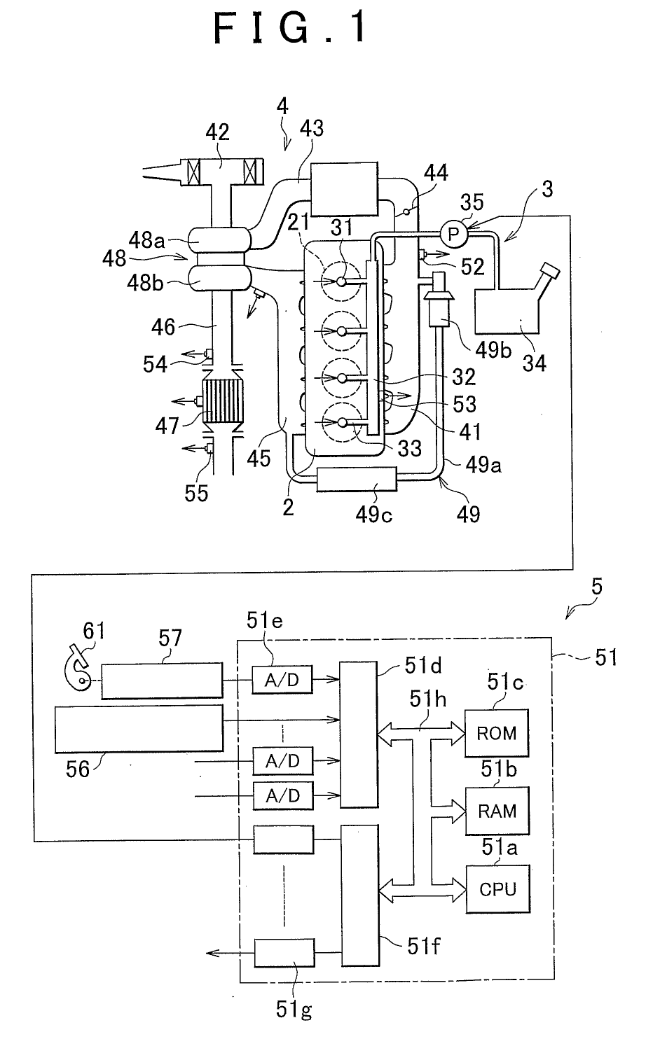

It should be noted that the description below is merely an illustration of an example embodiment of the present invention. Therefore, as discussed later, the present invention should not be limited in any way to the specific configurations of the embodiment described below. Various modifications that may be made to the embodiment will be collectively described at the end of the specification, in order to avoid such descriptions from interrupting a comprehensive understanding of the description of the embodiment by providing them in the course of the description of the embodiment.

<Overall System Configuration> FIG. 1 is a schematic diagram showing the overall configuration of an engine control system 1 to which the embodiment of the present invention is applied. Referring to FIG. 1, the engine control system 1 includes an engine 2, a fuel injection device 3, an intake/exhaust device 4, and an engine control device 5. In this embodiment, the engine 2 includes a plurality of combustion chambers 21 arranged in series with each other.

<<Fuel Injection Device>> The fuel injection device 3 includes a plurality of nozzles 31 and a fuel injection device 3 is provided for each combustion chamber 21. The nozzles 31 of this embodiment are conventional piezo-type fuel injection nozzles. Each nozzle 31 is disposed for each combustion chamber 21.

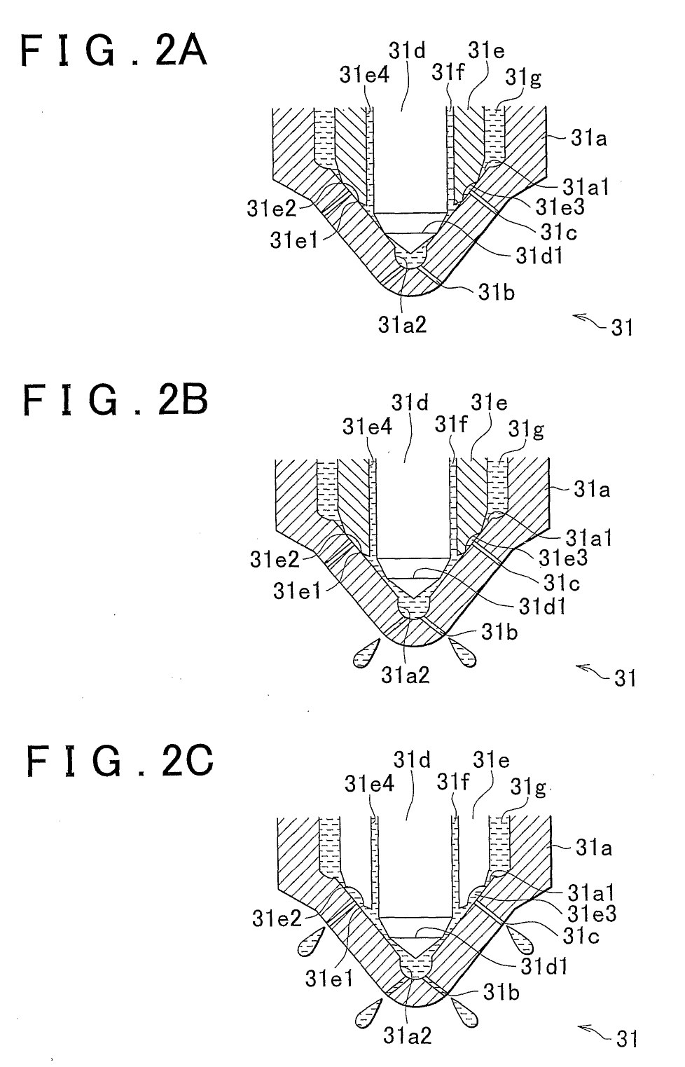

FIG. 2A to FIG. 2C are side cross sectional views showing enlarged views of the tip of the nozzle 31 shown in FIG. 1. Referring to FIG. 2A, a housing 31a, which constitutes the main body of the nozzle 31, is constituted of a tubular member with a closed tip. The tip of the housing 31a is generally formed in the shape of an inverted cone. The fuel injection device 3 (nozzle 31) is configured such that the tip of the housing 31a is exposed to the combustion chamber 21 (see FIG. 1) so that fuel is directly injected into the combustion chamber 21.

Inside the housing 31a are formed a seat portion 31a1 and a suction chamber 31a2. The seat portion 31a1 is formed as the inner side surface of a truncated conical depression. The suction chamber 31a2 is connected to the lower end of the seat portion 31a1 in the drawing. The suction chamber 31a2 is formed as a depression that opens upward in the drawing.

At the tip of the housing 31a are provided a first injection hole 31b and a second injection hole 31c. The first injection hole 31b and the second injection hole 31c are each formed as a through hole that communicates the space inside the housing 31a with the space outside the housing.

In this embodiment, the first injection hole 31b is provided closer to the tip of the housing 31a (closer to the lower end in the drawing) than the second injection hole 31c is. That is, the first injection hole 31b is provided at a position corresponding to the suction chamber 31a2. Meanwhile, the second injection hole 31c is provided at a position corresponding to the seat portion 31a1.

In this embodiment, a plurality of first injection holes 31b are formed extending radially at equal angular intervals as viewed in plan from the central axis of the housing 31a extending vertically in the drawing. Likewise, a plurality of second injection holes 31c are formed extending radially at equal angles.

An inner needle valve 31d is accommodated in the housing 31, and is movable axially (vertically in the drawing). The inner needle valve 31d is constituted of a long and thin bar-like member. The inner needle valve 31d is disposed with its central axis on the central axis of the housing 31a.

The tip of the inner needle valve 31d is generally formed in the shape of a cone projecting outward at its middle. Specifically, the tip of the inner needle valve 31d is formed in a shape obtained by joining, in the following order, an inverted cone with a large conical angle, an inverted truncated cone with a small conical angle, and a column.

A seat contact portion 31d1 is provided at the tip of the inner needle valve 31d where the inverted cone and the inverted truncated cone are connected. The seat contact portion 31d1 is formed as an annular edge that projects outward so to liquid-tightly contact the seat portion 31a1 over its entire periphery.

An outer needle valve 31e is accommodated inside the housing 31a, but outside the inner needle valve 31d, and is movable axially (vertically in the drawing). The outer needle valve 31e constitutes a long and thin cylindrical member. The outer needle valve 31e is disposed with its central axis on the central axis of the housing 31a and the inner needle valve 31d. That is, in this embodiment, the fuel injection device 3 is configured so that the housing 31a, the inner needle valve 31d, and the outer needle valve 31e are moveable relative to each other in the direction of the central axis (vertically in the drawing).

The tip of the outer needle valve 31e is formed in the shape of a truncated cone projecting outward at its middle. Specifically, a first seat contact portion 31e1, a second seat contact portion 31e2, and a recess 31e3 are formed at the tip of the outer needle valve 31e.

The first seat contact portion 31e1 and the second seat contact portion 31e2 are each formed as an annular edge that projects outward so as to be able to liquid-tightly contact the seat portion 31a1 over its entire periphery. The first seat contact portion 31e1 is provided closer to the tip of the outer needle valve 31e than the second seat contact portion 31e2 is.

The annular recess 31e3 is formed between the first seat contact portion 31e1 and the second seat contact portion 31e2. The recess 31e3 is provided to communicate with the second injection hole 31c when the tip of the outer needle valve 31e (the first seat contact portion 31e1 and the second seat contact portion 31e2) are in tight contact with the seat portion 31a1.

An inner needle accommodation portion 31e4, which is the inner cylindrical surface of the outer needle valve 31e, is provided at a predetermined distance from the outer cylindrical surface of the inner needle valve 31d. That is, an inner fuel passage 31f, which is a space for fuel to pass through, is formed between the inner needle valve 31d and the outer needle valve 31e.

Meanwhile, an outer fuel passage 31g, which is a space for fuel to pass through, is formed between the outer needle valve 31e and the housing 31a.

As shown in FIG. 2B, the nozzle 31 of this embodiment is configured to inject fuel from the first injection hole 31b when the inner needle valve 31d rises to separate the seat contact portion 31d1 from the seat portion 31a1 so that fuel at high pressure is supplied via the inner fuel passage 31f to the suction chamber 31a2. The amount of fuel injected from the first injection hole 31b may be adjusted according to the lift amount of the inner needle valve 31d.

In addition, as shown in FIG. 2C, the nozzle 31 of this embodiment injects fuel from the second injection hole 31c when the outer needle valve 31e rises to separate the first seat contact portion 31e1 and the second seat contact portion 31e2 from the seat portion 31a1 so that fuel at high pressure is supplied via the inner fuel passage 31f and the outer fuel passage 31g to the second injection hole 31c. The amount of fuel injected from the second injection hole 31c may be adjusted according to the lift amount of the outer needle valve 31e.

Further, the nozzle 31 of this embodiment is configured to be in the state where the first injection hole 31b and the inner fuel passage 31f are communicated with each other and the second injection hole 31c and the inner fuel passage 31f and the outer fuel passage 31g are interrupted from each other (see FIG. 2B), or in the state where the first injection hole 31b, the second injection hole 31c, the inner fuel passage 31f, and the outer fuel passage 31g are communicated with each other (see FIG. 2C), according to the lifting state of the inner needle valve 31d and the outer needle valve 31e.

That is, in this embodiment, the fuel injection device 3 (nozzle 31) switches between a first fuel injection, in which only the first injection hole 31b is used (see FIG. 2B), and a second fuel injection, in which both the first injection hole 31b and the second injection hole 31c are used (see FIG. 2C), based on the operating conditions such as the engine load (which is obtained based on the output of an accelerator operation amount sensor 57 to be discussed later) and the fuel injection amount.

Referring again to FIG. 1, the fuel injection device 3 is of a known common rail type, in which each nozzle 31 is connected to a common rail 32 via a fuel supply pipe 33. A fuel pump 35 is provided in a fuel supply passage between the common rail 32 and a fuel tank 34.

<<Intake/Exhaust Device>> In order to be able to supply air (containing recirculated exhaust gas) to the combustion chamber 21 of the engine 2, to discharge exhaust gas from the combustion chamber 21, and to purify the exhaust gas, the intake/exhaust device 4 is configured as follows.

An intake manifold 41 is attached to the engine 2 to supply air to each combustion chamber 21. The intake manifold 41 is connected to an air cleaner 42 via an intake pipe 43. A throttle valve 44 is provided in the intake pipe 43.

An exhaust manifold 45, which constitutes the exhaust passage of this embodiment, is attached to the engine 2 to receive exhaust gas from each combustion chamber 21. The exhaust manifold 45 is connected to an exhaust pipe 46. A catalyst filter 47 is provided in the exhaust pipe 46, which constitutes the exhaust passage of this embodiment.

A turbocharger 48 is provided between the intake pipe 43 and the exhaust pipe 46. That is, the intake pipe 43 is connected to a compressor 48a side of the turbocharger 48, and the exhaust pipe 46 is connected to a turbine 48b side of the turbocharger 48.

An EGR device 49 is provided between the intake manifold 41 and the exhaust manifold 45. The EGR device 49 includes an EGR passage 49a, a control valve 49b, and an EGR cooler 49c.

The EGR passage 49a is a passage for recirculated exhaust gas (EGR gas), and connects the intake manifold 41 and the exhaust manifold 45.

The control valve 49b and the EGR cooler 49c are provided in the EGR passage 49a. The control valve 49b controls the amount of EGR gas that is supplied to the intake manifold 41. The EGR cooler 49c cools the EGR gas using the coolant for the engine 2.

<<Engine Control Device>> In order to control the operation of the engine control system 1, including the fuel injection device 3, the engine control device 5 as the control device of the present invention is configured as follows.

The engine control device 5 includes an electronic control unit (ECU) 51. The ECU 51 includes a microprocessor (CPU) 51a, random access memory (RAM) 51b, read only memory (ROM) 51c, an input port 51d, an A/D converter 51e, an output port 51f, a driver 51g, and a bidirectional bus 51h.

The CPU 51a, which serves as the injection amount deviation output section (injection amount deviation output means) and the abnormality treatment direction section (abnormality treatment direction means) of the present invention, is configured to execute routines (programs) for controlling the operation of various parts in the engine control system 1. The RAM 51b is configured to temporarily store data as necessary while the CPU 51a is executing the routines. The ROM 51c preliminarily stores the routines (programs) discussed above, and tables (lookup tables and maps), parameters, and so forth to be referenced while the routines are being executed.

The input port 51d is connected via the A/D converter 51e to various sensors in the engine control system 1. The output port 51f is connected via the driver 51g to various parts in the engine control system 1 (such as the nozzle 31). The CPU 51a, the RAM 51b, the ROM 51c, the input port 51d, and the output port 51f are connected to each other via the bidirectional bus 51h.

An airflow meter 52, a rail pressure sensor 53, an upstream air-fuel ratio sensor 54, a downstream air-fuel ratio sensor 55, a crank angle sensor 56, and an accelerator operation amount sensor 57, are each connected to the input port 51d in the ECU 51 via the A/D converter 51e.

The airflow meter 52 generates an output voltage in accordance with the mass flow rate of intake air flowing in the intake pipe 43 per unit time (intake air flow rate Ga).

The rail pressure sensor 53, which serves as the actual injection amount output section (actual injection amount output means) of the present invention, is provided in the common rail 32. The rail pressure sensor 53 outputs a voltage that indicates the pressure in the common rail 32 (common rail pressure P). That is, the engine control device 5 of this embodiment obtains the amount of fuel actually injected for each cylinder (actual injection amount Qr) based on the amount of decrease in the common rail pressure P during fuel injection as indicated by the rail pressure sensor 53.

The upstream air-fuel ratio sensor 54 is provided in the exhaust pipe 46 upstream of the catalyst filter 47 in the flow direction of the exhaust gas. The upstream air-fuel ratio sensor 54 is a current limit-type oxygen concentration sensor that can precisely sense the air-fuel ratio over a wide range. The upstream air-fuel ratio sensor 54 outputs a voltage that indicates the air-fuel ratio.

The downstream air-fuel ratio sensor 55 is provided in the exhaust pipe 46 downstream of the catalyst filter 47 in the flow direction of the exhaust gas. The downstream air-fuel ratio sensor 55 is an electromotive force-type (concentration cell-type) oxygen concentration sensor, and generates an output voltage that changes abruptly around the stoichiometric air fuel ratio.

The crank angle sensor 56 outputs a narrow pulse every time the crankshaft (not shown) of the engine 2 rotates through a predetermined angle (for example,) 10°, and outputs a wide pulse every time the crankshaft rotates by 360°. The engine speed NE is determined based on the output from the crank angle sensor 56.

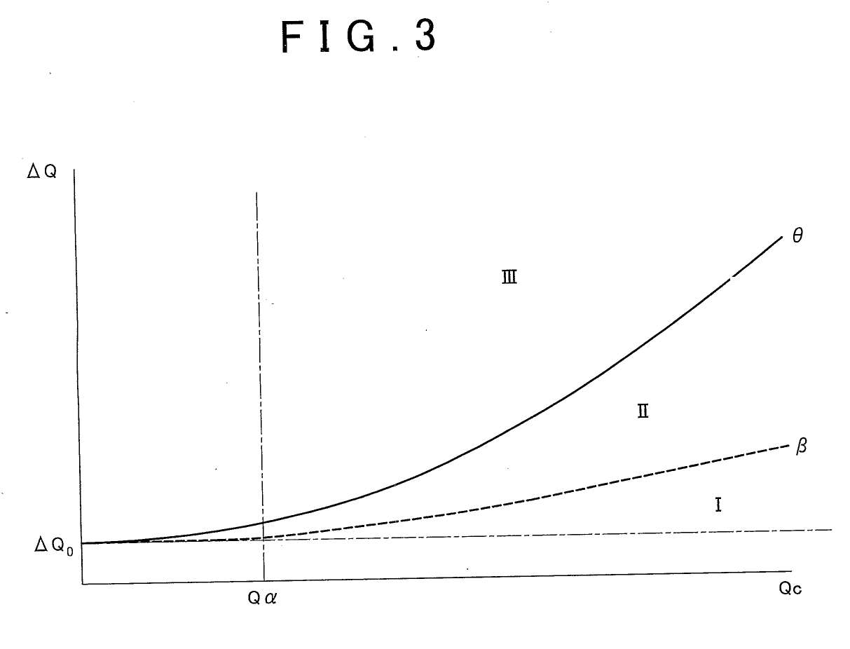

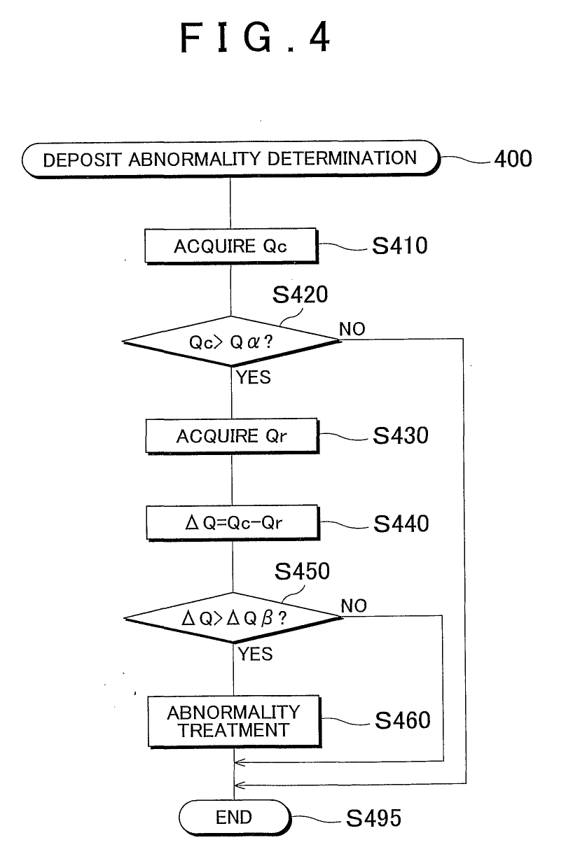

The accelerator operation amount sensor 57 generates an output voltage in accordance with the operation amount (depression amount) of an accelerator pedal 61.

<Outline of Operation to Detect Deposit Generation State in Embodiment> FIG. 3 is a conceptual diagram showing the outline of how the engine control device 5 of this embodiment shown in FIG. 1 detects the extent to which deposits have formed. FIG. 4 is a flowchart showing an example of the deposit abnormality determination routine that is executed by the engine control device 5 shown in FIG. 1.

The outline of the operation to detect (acquire or estimate) the extent to which deposits have formed in this embodiment will be described below with reference to FIG. 1 to FIG. 4. It should be noted that in the description of the respective steps of the flowchart of FIG. 4, the reference numerals given in FIG. 1, FIG. 2A, FIG. 2B, and FIG. 2C are used as appropriate, and the term “step” is abbreviated as “S” (which also applies to the flowcharts described below).

In FIG. 3, the horizontal axis represents the command fuel injection amount Qc, and the vertical axis represents the injection amount deviation ΔQ. Here, the injection amount deviation ΔQ represents the deviation between the command fuel injection amount Qc and the actual injection amount Qr. ΔQ₀ represents the deviation between the command fuel injection amount Qc and the actual injection amount Qr when the second injection hole 31c not blocked by deposits. In this embodiment, ΔQ₀ is defined as 0 for the sake of convenience.

The curve β and the curve θ in FIG. 3 each represent the relationship between the command fuel injection amount Qc and the injection amount deviation ΔQ with a predetermined proportion of the effective cross sectional area of the second injection hole 31c blocked by a deposit. Here, the proportion of the blockage is about 10% for the curve β, and about 40% for the curve θ.

In the region I below the curve β, the amount of deposits that block the second injection hole 31c is so small that the deposits may be adequately removed during the second fuel injection, or during compulsory second fuel injection (hereinafter referred to as “normality compulsory fuel injection”) which is performed after the first fuel injection has been performed successively a predetermined number of times. Therefore, in this embodiment, no special abnormality treatment is performed in the region I.

In the region II above the curve β, the amount of deposits blocking the second injection hole 31c is not so small that the deposits may be adequately removed during the second fuel injection or the normality compulsory fuel injection discussed above. Therefore, in this embodiment, a predetermined abnormality treatment is performed in the region II and the region III above the curve β.

Here, as shown in FIG. 3, when deposits block the second injection hole 31c, the injection amount deviation ΔQ increases as the command fuel injection amount Qc increases. However, in the region where the command fuel injection amount Qc is small, it is difficult to recognize a significant difference in the injection amount deviation ΔQ the injection amount deviation ΔQ is generally negligible, even if the second injection hole 31c is blocked by deposits.

Specifically, in the curve β, at which about 10% of the effective cross sectional area of the second injection hole 31c is blocked by a deposit, the proportion of variation in the injection amount deviation ΔQ is extremely small when the command fuel injection amount Qc is small. Therefore, it is difficult to detect blockage of the second injection hole 31c based on the injection amount deviation ΔQ unless the command fuel injection amount Qc is larger than a predetermined value Qα.

This is for the following reason. When the lift amount of the outer needle valve 31e is small, the small gap between the first seat contact portion 31e1 and the second seat contact portion 31e2 and the seat portion 31a1 provides a flow resistance larger than that provided by a blockage of the second injection hole 31c by deposits. Therefore, in such a region, variations in the deposit amount cause negligible variations in the actual injection amount Qr, which makes it difficult to precisely detect the deposit amount based on the injection amount deviation ΔQ.

Thus, as shown in the flowchart of FIG. 4, the engine control device 5 of this embodiment determines whether the injection amount deviation ΔQ exceeds a predetermined level ΔQβ when the command fuel injection amount Qc is larger than the predetermined value Qα, and performs abnormality treatment based on the determination results.

The CPU 51a in the ECU 51 executes a deposit abnormality determination routine 400, shown in FIG. 4, at every predetermined intervals (crank angle).

When the deposit abnormality determination routine 400 is started, the command fuel injection amount Qc is first acquired in S410. Next, in S420, it is determined whether the command fuel injection amount Qc is larger than the predetermined value Qα. If the command fuel injection amount Qc is larger than the predetermined value Qα (S420=Yes), the process proceeds to S430 and the subsequent steps. On the other hand, if the command fuel injection amount Qc is less than the predetermined value Qα (S420=No), the processes in S430 and the subsequent steps are skipped.

In S430, the actual injection amount Qr is acquired based on the output of the rail pressure sensor 53. Next, in S440, the injection amount deviation ΔQ is acquired. That is, the process in S440, which causes the CPU 51a to acquire the injection amount deviation ΔQ to output the acquired value, corresponds to the injection amount deviation output means of the present invention.

Subsequently, in S450, it is determined whether the currently acquired injection amount deviation ΔQ is greater than the predetermined level ΔQp. Here, ΔQβ is obtained using a function or a map having the command fuel injection amount Qc and the common rail pressure P as parameters.

As a specific example, defining a map of ΔQβ having the command fuel injection amount Qc as a parameter as MapΔQβ(Qc), and the common rail pressure P at the time of preparing the map as Pbase, ΔQβ can be obtained by ΔQβ=(P/Pbase)^{1/2}×MapΔQβ(Qc).

If the injection amount deviation ΔQ is more than ΔQβ (S450=Yes), the process proceeds to S460, where a predetermined abnormality treatment (abnormality compulsory fuel injection, which is performed with conditions different from those of the normality compulsory fuel injection discussed above, error warning, or the like is performed. That is, the process in S460, which causes the CPU 51a to output various signals for the abnormality treatment, corresponds to the abnormality treatment command means of the present invention.

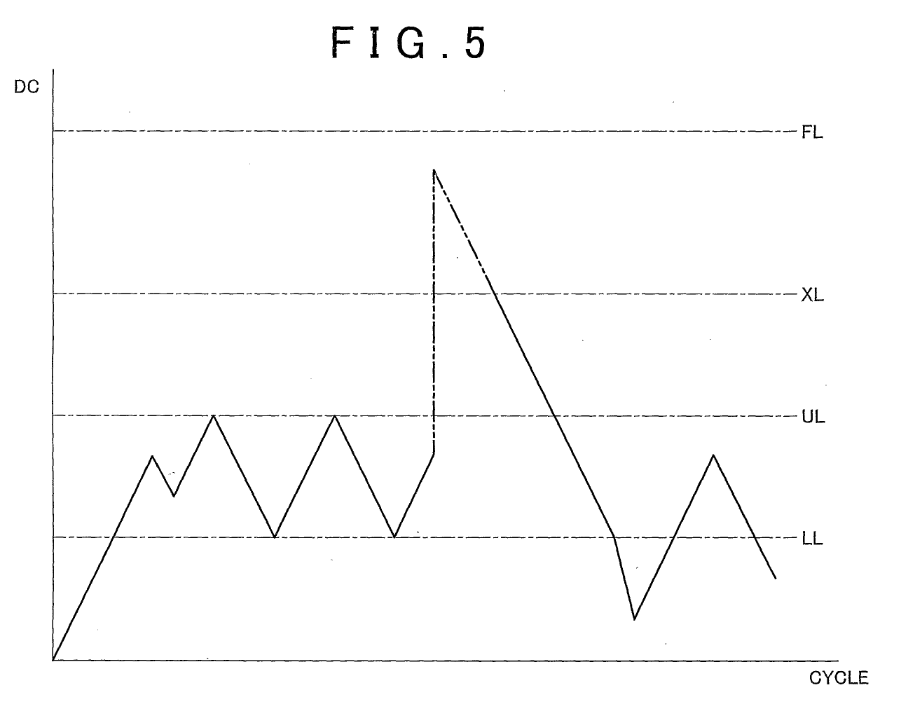

If the injection amount deviation ΔQ is not more than ΔQβ (S450=No), the process in S460 is skipped. Then, this routine is temporarily ended (S495).

<Specific Example of Operation to Detect Deposit Generation State in Embodiment> FIG. 5 is a conceptual diagram showing a specific example of how the engine control device 5 of this embodiment shown in FIG. 1 detects the extent to which deposits have formed.

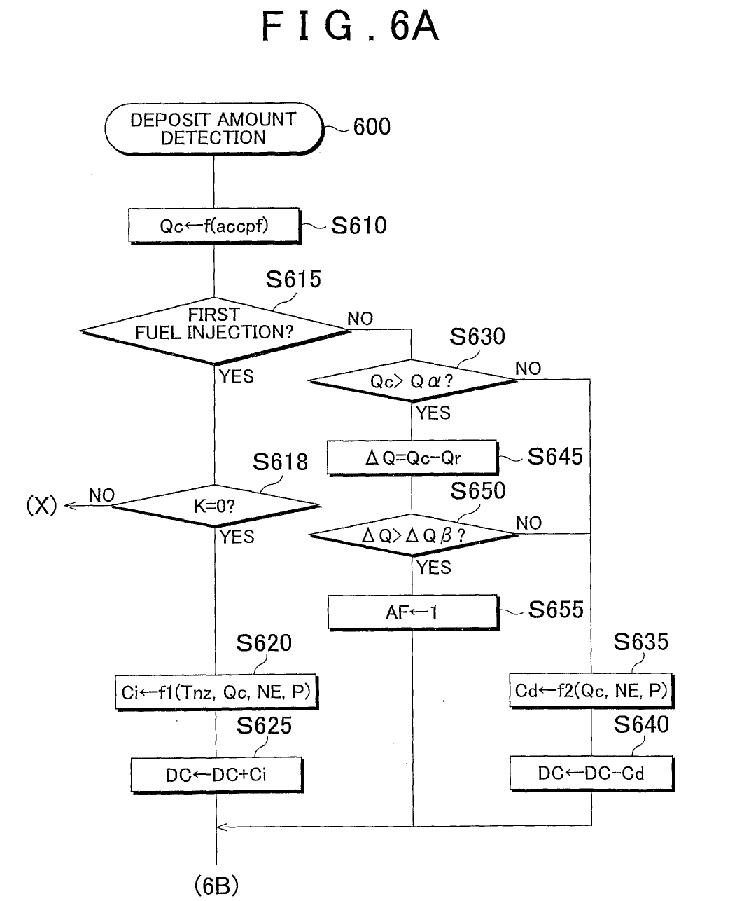

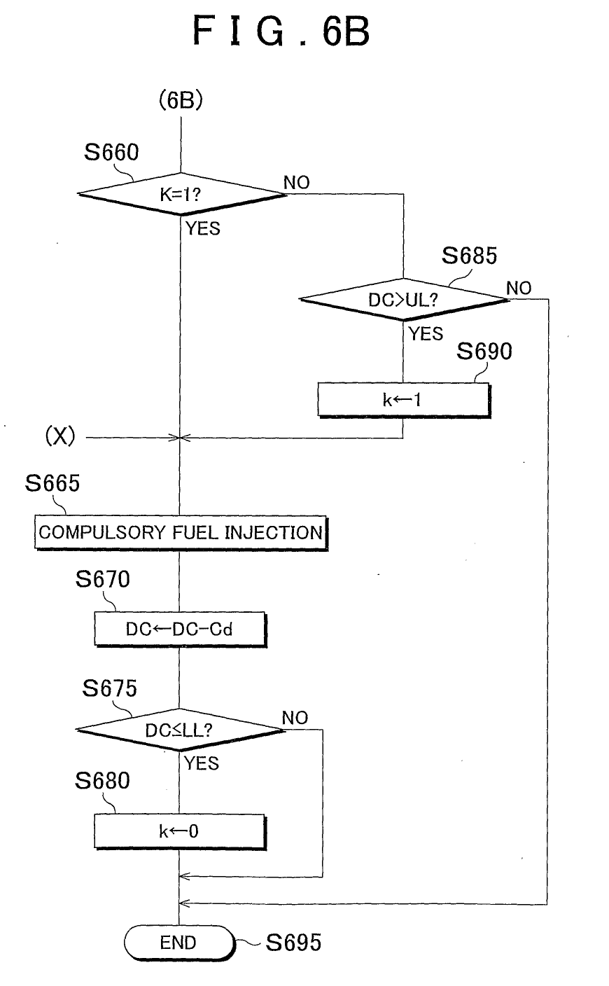

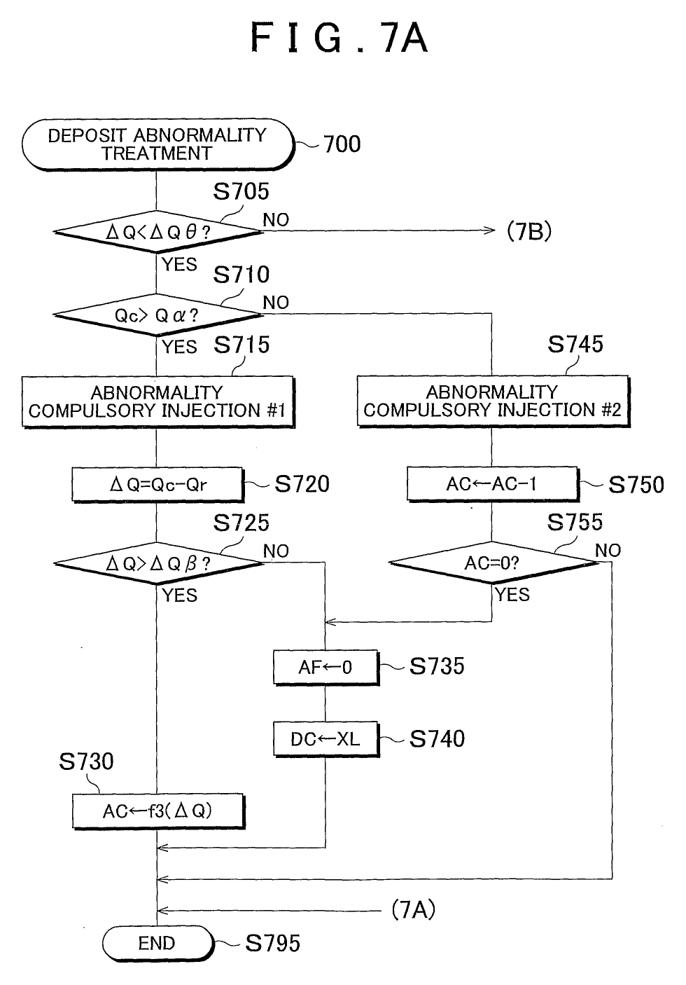

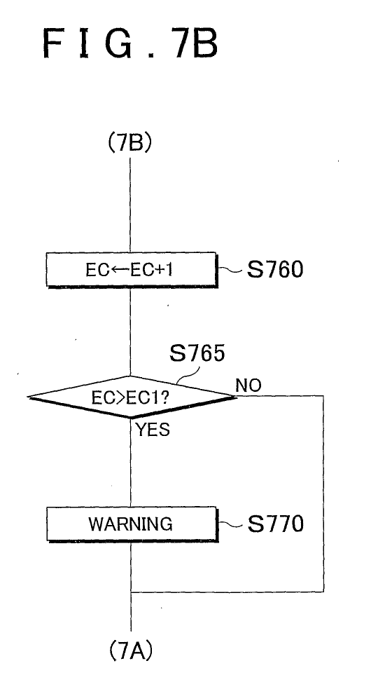

FIG. 6A and FIG. 6B are flowcharts showing an example of the deposit amount estimation routine that is executed by the engine control device 5 shown in FIG. 1 (FIG. 6B is a continuation of the flowchart of FIG. 6A). FIG. 7A and FIG. 7B are flowcharts showing an example of the deposit abnormality treatment routine that is executed by the engine control device 5 shown in FIG. 1 (FIG. 7B is a continuation of the flowchart of FIG. 7A).

Next, a specific example of detecting (acquiring or estimating) the extent to which deposits have formed in this embodiment will be described with reference to FIG. 5 to FIG. 7B.

In FIG. 5, the horizontal axis represents the number of cycles, and the vertical axis represents the value of a deposit counter DC. Here, the deposit counter DC is a counter operated in a software manner to estimate the amount of deposits that have formed around the second injection hole 31c, and incremented and decremented according to the operating conditions (fuel injection conditions).

In this specific example, the deposit counter DC is incremented when the first fuel injection mode is performed, and decremented when the second fuel injection mode is performed. Then, when the deposit counter DC reaches an increment maximum UL, the normality compulsory fuel injection is performed. The deposit counter DC is decremented along with the normality compulsory fuel injection.

In addition, in this specific example, the deposit generation state is acquired based on the injection amount deviation ΔQ when the command fuel injection amount Qc is larger than the predetermined value Qα. Then, when the injection amount deviation ΔQ is greater than the predetermined level ΔQβ, the abnormality treatment is performed. Specifically, the abnormality compulsory fuel injection is performed when ΔQβ<ΔQ<ΔQθ, and an error warning is issued when ΔQθ≦ΔQ. Here, ΔQβ corresponds to XL in FIG. 5, and ΔQθ corresponds to FL in FIG. 5.

That is, when the amount deposits formed, determined based on the injection amount deviation ΔQ acquired when the command fuel injection amount Qc is larger than the predetermined value Qα (hereinafter referred to as “acquired deposit amount”), exceeds amount corresponding to the value FL of the deposit counter DC, an error warning is issued. Meanwhile, when the determined amount of deposits does not exceed the amount corresponding to the value FL of the deposit counter DC, but does exceed the amount corresponding to the value XL of the deposit counter DC, the abnormality compulsory fuel injection is performed.

The CPU 51a in the ECU 51 executes a deposit amount detection routine 600 shown in FIG. 6A at predetermined intervals (crank angle).

If the deposit amount detection routine 600 is executed, first, in S610, the command fuel injection amount Qc is acquired using a predetermined map based on an accelerator pedal operation amount accpf obtained based on the output of the accelerator operation amount sensor 57 and so forth.

Next, in S615, it is determined whether the current fuel injection is the first fuel injection. If the current fuel injection is the first fuel injection (S615=Yes), the process proceeds to S618, where it is determined whether a compulsory fuel injection flag k has been reset. If the compulsory fuel injection flag k has been reset (S618=Yes), the process proceeds to S620. If the compulsory fuel injection flag k has been set (S618=No), the process proceeds to (X) in the drawing (the process proceeds to S665, which is described later, where the normality compulsory fuel injection is performed).

In S620, a counter increment value Ci is acquired. The counter increment value Ci is acquired using a map or the like based on a nozzle temperature Tnz, the command fuel injection amount Qc, the engine speed NE, the common rail pressure P, and so forth. Then, in S625, the deposit counter DC is incremented by the value Ci, and the process proceeds to S660.

If the current fuel injection is not the first fuel injection mode (S615=No), that is, if the current fuel injection is the second fuel injection mode, the processes in S618, S620, and S625 are skipped, and the process proceeds to S630. In S630, it is determined whether the command fuel injection amount Qc is larger than the predetermined value Qα.

If the command fuel injection amount Qc is not larger than the predetermined value Qα (S630=No), the process proceeds to S635, where a counter decrement value Cd is acquired. The counter decrement value Cd is acquired using a map or the like based on the command fuel injection amount Qc, the engine speed NE, the common rail pressure P, and so forth. Then, in S640, the deposit counter DC is decremented by the value Cd, and the process proceeds to S660.

If the command fuel injection amount Qc is larger than the predetermined value Qα (S630=Yes), the process proceeds to S645, where the injection amount deviation ΔQ is determined. Then, in S650, it is determined whether the currently injection amount deviation ΔQ exceeds the predetermined level ΔQβ.

If the injection amount deviation ΔQ is not more than ΔQβ (S650=No), the processes in S635 and S640 are performed, after Which the process proceeds to S660. On the other hand, if the injection amount deviation ΔQ is more than ΔQβ (S650=Yes), the process proceeds to S655, where an abnormality flag AF is set. Then, the process proceeds to S660.

Referring to FIG. 6B, when the process in S660 is executed. In S660, it is determined whether the compulsory fuel injection flag k has been set.

If the compulsory fuel injection flag k has been set (S660=Yes), the normality compulsory fuel injection is performed in a predetermined fuel injection pattern (crank angle and injection pressure) (S665). Specifically, the normality compulsory fuel injection is performed at the time of post injection, for example. Then, the deposit counter DC is decremented using a counter decrement value Cd obtained in the same way as in S635, based on the fuel injection conditions for the normality compulsory fuel injection (S670).

Subsequently, in S675, it is determined whether the value of the deposit counter DC is equal to or below a value LL. If the value of the deposit counter DC is equal to or below the value LL (S675=Yes), the compulsory fuel injection flag k is reset in S680. If the value of the deposit counter DC exceeds the value LL (S675=No), the process in S680 is skipped. Then, this routine is temporarily ended (S695).

If the compulsory fuel injection flag k has not been set (S660=No), the process proceeds to S685. In S685, it is determined whether the value of the deposit counter DC exceeds the value UL. If the value of the deposit counter DC exceeds the value UL (S685=Yes), the compulsory fuel injection flag k is set in S690. If the value of the deposit counter DC is does not exceed the value UL (S685=No), the process in S690 is skipped, and this routine is temporarily ended (S695).

When the abnormality flag AF is set, a deposit abnormality treatment routine 700 shown in FIG. 7A is executed.

When the deposit abnormality treatment routine 700 is started, it is first determined, in S705, whether the injection amount deviation ΔQ is smaller than the predetermined level ΔQθ.

If the injection amount deviation EQ is smaller than the predetermined level ΔQθ (S705=Yes), the process proceeds to S710, where it is determined whether the command fuel injection amount Qc is larger than the predetermined value Qα.

If the command fuel injection amount Qc is larger than the predetermined value Qα (S710=Yes), the process proceeds to S715. Then, in S715, the abnormality compulsory fuel injection is performed. The abnormality compulsory fuel injection is performed in a fuel injection pattern different from that for the normality compulsory fuel injection. Specifically, the abnormality compulsory fuel injection is performed at the same crank angle as in the normality compulsory fuel injection (in this specific example, at the time of post injection) and at an injection pressure higher than that of the normality compulsory fuel injection. Then, in S720, the injection amount deviation ΔQ is acquired, and it is determined whether the injection amount deviation ΔQ is more than ΔQβ (S725).

If the injection amount deviation ΔQ is exceeds ΔQβ (S725=Yes), an abnormality counter AC is set based on the injection amount deviation ΔQ (S730), and this routine is temporarily ended (S795). If the injection amount deviation ΔQ is not more than ΔQβ (S725=No), the process in S730 is skipped. The process proceeds to S735 and S740, and this routine is temporarily ended (S795). The abnormality flag AF is reset in S735, and the value of the deposit counter DC is set to the predetermined value XL in S740.

If the command fuel injection amount Qc is not larger than the predetermined value Qα (S710=No), the process proceeds to S745. In S745, the abnormality compulsory fuel injection is performed in a fuel injection pattern different from that in S715 (in such a pattern as to promote removal of the deposit).

Specifically, the abnormality compulsory fuel injection is performed using in combination the injection timing for the normality compulsory fuel injection (in the specific example, at the time of post injection) and an injection timing different from that for the normality compulsory fuel injection. Then, the abnormality counter AC is decremented in S750, and it is determined in S755 whether the value of the abnormality counter AC is 0.

If the value of the abnormality counter AC is 0 (S755=Yes), the process proceeds to S735, where the abnormality flag AF is reset, and the value of the deposit counter DC is set to the predetermined value XL in S740. Then, this routine is temporarily ended (S795). If the value of the abnormality counter AC is not 0 (S755=No), this routine is temporarily ended (S795).

If the injection amount deviation ΔQ is equal to or exceeds the predetermined level ΔQθ (S705=No), the process proceeds to S760 in FIG. 7B, where an error warning counter EC is incremented. Then, the process proceeds to S765, where it is determined whether the value of the error warning counter EC exceeds a predetermined value EC1.

If the value of the error warning counter EC exceeds the predetermined value EC1 (S765=Yes), the process proceeds to S770, where an error warning is issued. The error warning is issued using a predetermined lamp or the like. Then, the routine is temporarily ended (S795). If the value of the error warning counter EC is not more than the predetermined value EC1 (S765=No), the process in S770 is skipped, and this routine is temporarily ended (S795).

That is, the processes in S645 and S720, which cause the CPU 51a to acquire the injection amount deviation ΔQ and output the acquired value, correspond to the injection amount deviation output means of the present invention. Meanwhile, the various processes for the various abnormality treatments discussed above performed by the CPU 51a when ΔQ is more than the predetermined value ΔQβ or ΔQθ (the processes in the deposit abnormality treatment routine 700 or in S655 to S680) correspond to the abnormality treatment command means of the present invention.

<Effect Achieved by Configuration of Embodiment> In the configuration of this embodiment, the actual injection amount Qr is acquired based on the output of the rail pressure sensor 53 as the actual injection amount output section (actual injection amount output means). Based on the actual injection amount Qr and the command fuel injection amount Qc, the injection amount deviation ΔQ is determined and output by the CPU 51a as the injection amount deviation output section (injection amount deviation output means). Then, when the injection amount deviation ΔQ is exceeds the predetermined value ΔQβ or ΔQθ, various signals for predetermined abnormality treatment are output by the CPU 51a as the abnormality treatment direction section (abnormality treatment command means).

In addition, in the configuration of this embodiment, the abnormality treatment is performed based on the injection amount deviation ΔQ when the actual injection amount Qr exceeds the predetermined value Qα. That is, the amount of deposits is determined based on the injection amount deviation ΔQ when the fuel injection amount is relatively large during the second fuel injection. On the other hand, the deposit amount is estimated using a counter during the first fuel injection and when the fuel injection amount is small during the second fuel injection.

According to such a configuration of this embodiment, the extent to which deposits have formed at the second injection hole 31c may be more accurately determined or estimated. This allows to more appropriately perform predetermined abnormality treatment such as compulsory fuel injection from the second injection hole 31c (the normality compulsory fuel injection or the abnormality compulsory fuel injection), error warning, or the like. Thus, according to the configuration of this embodiment, engine control may be more appropriately performed.

In the configuration of this embodiment, the actual injection amount Qr is determined for each cylinder based on the amount of decrease in the common rail pressure P during fuel injection detected by the rail pressure sensor 53.

According to such a configuration, the extent to which deposits have formed at each nozzle 31 may be individually specified. This enables the various abnormality treatments to be appropriately performed for each specific nozzle 31 at which the amount of deposits formed has increased or an abnormality has occurred due to the formation of a large amount of deposits. Therefore, it is possible to avoid performing processes such as compulsory fuel injection on nozzles 31 at which no abnormality has occurred, which suppresses deterioration in the fuel efficiency.

Hereinafter, several typical modifications will be illustrated. It should be understood that the present invention is not limited to the modifications described below. In addition, a plurality of modifications may be applied in combination as appropriate, without departing from the technical scope of the present invention.

(A) The engine control system 1 and the engine control device 5 may be applied to any type of engine including but not limited to gasoline engines, diesel engines, methanol engines, and bioethanol engines. The number of cylinders and the arrangement of the cylinders (inline, V, or horizontally opposed) is also not specifically limited.

(B) To detect the engine load, a throttle position sensor that outputs a signal in accordance with the opening of the throttle valve 44 may be used instead of the accelerator operation amount sensor 57.

(C) To acquire the actual injection amount Qr, the output of the upstream air-fuel ratio sensor 54 may be used instead of the output of the rail pressure sensor 53. That is, the engine control device 5 (ECU 51) may acquire the average actual injection amount Qr of all the cylinders based on the output of the upstream air-fuel ratio sensor 54 and the airflow meter 52 and an EGR rate map.

(D) The methods to acquire the command fuel injection amount Qc and the operation values for the various counters are also not limited to those described in the embodiment and the preceding example. For example, the maps, the tables, and the functions may be interchanged with each other.

In addition, the command fuel injection amount Qc may be determined by making a predetermined correction to a predetermined target fuel injection amount Qt.

Specifically, in diesel engines the command fuel injection amount Qc may be determined, for example, by acquiring the target fuel injection amount Qt using a predetermined map based on the accelerator pedal operation amount accpf as in S610, and correcting the target fuel injection amount Qt according to a charging pressure Pb, the intake air flow rate Ga, an atmospheric pressure Pa, and so forth.

Alternatively, in gasoline engines, the command fuel injection amount Qc may be acquired, for example, by acquiring the target fuel injection amount Qt based on the intake air flow rate Ga, the engine speed NE, a target air-fuel ratio afr, and so forth, and correcting the target fuel injection amount Qt with a feedback correction amount Qfb, which is based on the output of the upstream air-fuel ratio sensor 54 and the downstream air-fuel ratio sensor 55. Here, the target air-fuel ratio afr is obtained based on the output from the accelerator operation amount sensor 57 and so forth.

The parameters used are also not limited to those used in the embodiment and the above example.

Specifically, an in-cylinder intake air amount Mc may be used instead of the intake air flow rate Ga, for example. In this case, the in-cylinder intake air amount Mc of the cylinder that is currently about to enter the intake stroke may be obtained based on parameters such as the intake air flow rate Ga and a target engine speed N, which is obtained based on the output of the accelerator operation amount sensor 57 (the operation amount of the accelerator pedal 61), a table stored in the ROM 51c, and so forth.

(E) As the standard for calculating the injection amount deviation ΔQ, the target fuel injection amount Qt may be used in place of the command fuel injection amount Qc.

(F) The configuration of the nozzle 31 is also not limited to that of the described embodiment. For example, the nozzle 31 may be configured so that fuel may be injected from only the second injection hole 31c. Alternatively, the nozzle 31 may be configured so that fuel may be controllably injected from the first injection hole 31b and the second injection hole 31c with a single needle valve.

In particular, according to the present invention, the extent to which deposits have formed at the first injection hole 31b may also be acquired or estimated in the same way. Therefore, the present invention may be favorably applied also to a fuel injection device 3 including a nozzle 31 that does not include a second injection hole 31.

(G) It should be understood that other modifications not specifically mentioned may also fall within the scope of the present invention as long as they do not depart from the essence of the present invention. Of the components constituting the means for solving the problem of the present invention, the components described in terms of their effects and functions may include any structure that achieves those effects and functions, in addition to the specific structures of the described embodiment and modifications.

1.-9. (canceled)

10. A control device for an internal combustion engine, comprising:
a fuel injection device that switches between a first fuel injection mode, in which fuel is injected into a combustion chamber from only a first injection hole, and second fuel injection mode, in which fuel is injected into the combustion chamber from the first injection hole and a second injection hole;
an actual injection amount output section that outputs a signal indicating an actual injection amount, which represents the amount of fuel actually injected from the fuel injection device, in the second fuel injection mode;
an injection amount deviation output section that outputs a signal indicating a deviation of the actual injection amount from a command fuel injection amount, which is input to the fuel injection device to cause the fuel injection device to inject a predetermined target fuel injection amount of fuel; and
an abnormality treatment direction section that outputs an abnormality treatment signal, which enables an abnormality treatment different from normality treatment based on the output of the injection amount deviation output section if the deviation exceeds a predetermined value, wherein the abnormality treatment direction section outputs the abnormality treatment signal based on the output of the injection amount deviation output section when the target fuel injection amount or the command fuel injection amount exceeds a predetermined amount.

11. The control device according to claim 10, wherein the abnormality treatment direction section outputs the abnormality treatment signal when the target fuel injection amount or the command fuel injection amount exceeds the predetermined fuel injection amount and the deviation exceeds a predetermined deviation value.

12. The control device according to claim 10, wherein the abnormality treatment is a compulsory injection of fuel from the second injection hole.

13. The control device according to claim 10, wherein the abnormality treatment is a determination that a malfunction has occurred in the fuel injection device.

14. A control method for an internal combustion engine including a fuel injection device that switches between a first fuel injection mode, in which fuel is injected into a combustion chamber from only a first injection hole, and a second fuel injection mode, in which fuel is injected into the combustion chamber from the first injection hole and a second injection hole, the control method comprising:
outputting a signal that indicates an actual injection amount, which represents the amount of fuel actually injected from the fuel injection device, in the second fuel injection mode;
outputting a signal that indicates a deviation of the actual injection amount from a command fuel injection amount, which is input to the fuel injection device to cause the fuel injection device to inject a predetermined target fuel injection amount of fuel; and
outputting an abnormality treatment signal, which enables an abnormality treatment different from normality treatment when the target fuel injection amount or the command fuel injection amount exceeds a predetermined amount, based on the indicated deviation of the actual injection amount if the deviation exceeds a predetermined value.
